(19) United States
(12) Patent Application Publication
(10) Pub. No.: US 2025/0256208 A1
(43) Pub. Date: Aug. 14, 2025

(54) ASSOCIATING ARTIFICIAL INTELLIGENCE (AI) GENERATED CONTENT WITH PLAYERS AND OUTCOMES

(71) Applicant: IGT, Las Vegas, NV (US)

(72) Inventor: Dwayne Nelson, Las Vegas, NV (US)

(21) Appl. No.: 18/440,501

(22) Filed: Feb. 13, 2024

(51) Int. Cl. A63F 13/60

(52) U.S. Cl. CPC A63F 13/60

(57) ABSTRACT

Embodiments of the present disclosure are directed to generating content for use in an electronic game using generative Artificial Intelligence (AI) and recording information about the content and use of the content in the game. The game can include content played on an Electronic Gaming Machine (EGM), video lottery terminal (VLT), kiosk, web browser, mobile phone or virtual reality device. The novel part of the invention is having the system store and associate which AI content and which AI prompts were used for each game play. This may be to provide a regulatory game recall feature so that the operator or regulator can review what each player saw. This allows for the games to be recreated with the correct content and to allow the operator or regulator to review which AI prompt was used for a game outcome.

### BACKGROUND

The present disclosure is generally directed to generating content for use in an electronic game and more particularly to generating content for use in an electronic game using generative artificial intelligence and recording information about the content and use of the content in the game.

Generative Artificial Intelligence (AI) system as known in the art can generate pictures, icons, symbols, text, video, other graphics, sounds, and other content. If such content is used in an electronic game, it becomes important for regulator and management reasons to track the use of the AI generated content.

### BRIEF SUMMARY

Embodiments of the present disclosure are directed to generating content for use in an electronic game using generative artificial intelligence and recording information about the content and use of the content in the game. According to one embodiment, a method for generating content for an electronic game can comprise generating a prompt describing content for the electronic game, providing the prompt to a generative AI system, receiving the content for the electronic game from the generative AI system, applying the received content for the electronic game to the electronic game, and recording the generated prompt, the received content, and game information for a session of the electronic game to which the received content was applied. Recording the generated prompt, the received content, and game information for the session of the electronic game to which the received content was applied can comprise recording a unique identifier for the session of the electronic game, a date and time for the session of the electronic game, information identifying the generative AI system, some or all of the received content, an indication of which content of the received content was applied to the session of the electronic game, and/or other information. A replay of the session of the electronic game can be provided using the recorded generated prompt, received content, and game information for the session of the electronic game to which the received content was applied.

According to another embodiment, a gaming system can comprise a processor and a memory coupled with and readable by the processor. The memory can store therein a set of instructions which, when executed by the processor, causes the processor to generate a prompt describing content for the electronic game, provide the prompt to a generative AI system, receive the content for the electronic game from the generative AI system, apply the received content for the electronic game to the electronic game, and record the generated prompt, the received content, and game information for a session of the electronic game to which the received content was applied.

Recording the generated prompt, the received content, and game information for the session of the electronic game to which the received content was applied can comprise recording a unique identifier for the session of the electronic game, a date and time for the session of the electronic game, information identifying the generative AI system, some or all of the received content, an indication of which content of the received content was applied to the session of the electronic game, and/or other information. In some cases, the instructions can further cause the processor to provide a replay of the session of the electronic game using the recorded generated prompt, received content, and game information for the session of the electronic game to which the received content was applied.

According to yet another embodiment, a gaming venue host system can comprise a processor and a memory coupled with and readable by the processor. The memory can store therein a set of instructions which, when executed by the processor, causes the processor to generate a prompt describing content for the electronic game, provide the prompt to a generative AI system, receive the content for the electronic game from the generative AI system, apply the received content for the electronic game to the electronic game, and record the generated prompt, the received content, and game information for a session of the electronic game to which the received content was applied.

Recording the generated prompt, the received content, and game information for the session of the electronic game to which the received content was applied can comprise recording a unique identifier for the session of the electronic game, a date and time for the session of the electronic game, information identifying the generative AI system, some or all of the received content, an indication of which content of the received content was applied to the session of the electronic game, and/or other information. In some cases, the instructions can further cause the processor to provide a replay of the session of the electronic game using the recorded generated prompt, received content, and game information for the session of the electronic game to which the received content was applied. Providing the replay of the session of the electronic game using the recorded generated prompt, received content, and game information for the session of the electronic game to which the received content was applied can comprise receiving, from a gaming system, a request to replay the session of the electronic game using the recorded generated prompt, received content, and game information for the session of the electronic game to which the received content was applied, retrieving the recorded generated prompt, received content, and game information for the session of the electronic game to which the received content was applied, and providing the retrieved generated prompt, received content, and game information for the session of the electronic game to which the received content was applied to the gaming system.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary gaming system according to one embodiment of the present disclosure.

FIG. 3 is a block diagram illustrating additional details of components of an exemplary gaming venue host system according to one embodiment of the present disclosure.

FIG. 4 is a flowchart illustrating an exemplary process for generating content for an electronic game according to one embodiment of the present disclosure.

FIG. 5 is a flowchart illustrating an exemplary process for providing a replay function for an electronic game session according to one embodiment of the present disclosure.

### DETAILED DESCRIPTION

Embodiments of the present disclosure are directed to generating content for use in an electronic game using generative Artificial Intelligence (AI) and recording information about the content and use of the content in the game. The game can include content played on an Electronic Gaming Machine (EGM), video lottery terminal (VLT), kiosk, web browser, mobile phone or virtual reality device. The novel part of the invention is having the system store and associate which AI content and which AI prompts were used for each game play. This may be to provide a regulatory game recall feature so that the operator or regulator can review what each player saw. This allows for the games to be recreated with the correct content and to allow the operator or regulator to review which AI prompt was used for a game outcome.

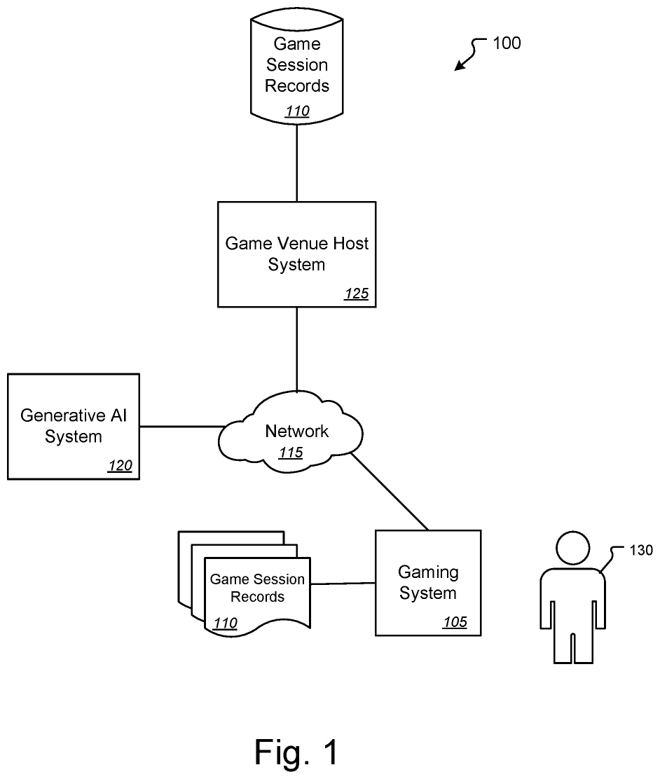

FIG. 1 is a block diagram illustrating an exemplary environment in which embodiments of the present disclosure can be implemented. As illustrated in this example, the environment 100 can include a gaming system 105. The gaming system can comprise, but is not limited to, an EGM, VLT, kiosk, web browser, mobile phone, virtual reality device, or any other device capable of executing an electronic game. Such a game can include, but is not limited to, slots, video slots, video poker, keno, blackjack, etc. to be played by a player 130, e.g., in a casino or other gaming venue.

The gaming system 105 can be coupled with a communications network 115. The communications network can comprise any one or more wired and/or local-area and/or wide-area networks as known in the art including, but not limited to, the Internet. Also coupled with the communications network 115 can be a generative AI system 120 and a gaming venue host system 125 for a casino or other gaming venue in which the gaming system 105 is installed. Each of the generative AI system 120 and gaming venue host system 125 can comprise any one or more servers and/or other computing devices as known in the art.

Generally speaking, generative AI as may be provided by generative AI system 120 is a type of AI that can generate pictures, movies, text, language, sounds, and/or other content based on prompts. DALL-E is an example generative AI website and application that generates images based on input prompts. Midjourney is another popular generative AI application for images. A user of such systems can provide a prompt and the generative AI can provide one or more images or other content based on the prompts. The prompt can be human readable text that describes, in human language, the type of content the user wants. For example, the user could provide the prompt “a picture of a cute cat” or “a cartoon of a cute cat eating a fish”. This is the current state of art for generative AI. Prompts could also be in other formats such as binary, XML, json or other formats that can provide the information desired.

In some cases, generative AI can be used to generate content to be utilized within an electronic game. In a gaming context, it should be clear that the AI generated content can include, but is not limited to, slot symbols, background images or scenes, pay lines, button panels, sounds, animations, card backs, card faces, bingo cards, keno cards, icons, avatars or characters, shaders, borders, titles, frames, win celebrations, player prompts or message, and/or other content. In some cases, generative AI could be used for custom messages or to translate messages, e.g., “Provide a congratulatory message in French.”

Embodiments of the present disclosure are directed to recording and associating the AI generation prompt and generative AI content created with the game play session and/or the player 130. This may be necessary for regulatory purposes such as game recall, i.e., a game history feature. Recall can be used necessary when a player, operator, or regulator wants to review the outcome of a game in the past. For example, a player 130 thinks he didn't win the right amount, so he contacts the attendant at the casino. The attendant can invoke the recall feature to review the information and images about that outcome to determine if the player 130 was paid correctly. With generative AI, the operator should see which content was shown to the player 130 since it can be different than the content shown to other players. For example, for one outcome the player 130 is shown slot win of 3 sports car symbols. For the exact same outcome, another player might see a slow win of 3 cruise ship symbols. To be extra clear, imagine that the random numbers generated by the gaming system 105 to be the values 1,2,3,4 and 5 because it is a 5-reel slot. When another player plays the same game, either on the same or different gaming system, and that gaming system also generates random values 1,2,3,4 and 5, the player 130 sees sports car symbols and the other player sees cruise ship symbols. In the present disclosure the gaming system 105 can associate the sports car symbols with the game played by one player 130 and associated to that player 130 while it associates the cruise ship symbols with the game played by and associate to another player.

In some embodiments, the gaming system 105 can have content associated with an individual player, while in other embodiments the gaming system 105 or gaming venue host system 125 can have content associated with a category of player such as a high roller, a poker player, a sports fan, etc. When a player 130 starts a gaming session, the gaming system 105 or gaming venue host system 125 can determine the “type” of player and provide the correct content for the current player 130.

In some embodiments, the generative AI system 120 can provide multiple results such as multiple images. For example, the prompt “Picture of a cherry smiling” might result in three possible images by the generative AI system 120. In some embodiments, the gaming system or gaming venue host system 125 can store in a set of game session information 110 the results from the generative AI system 120, while only using one or more of those results. For example, the generative AI system 120 might have returned three results and the gaming system 105 only used one, yet the gaming system 105 or gaming venue host system 125 can retain the unused images. This information can be later used to determine how best to pick from the generative AI results. In one embodiment, the gaming system 105 or gaming venue host system 125 can record which images it picked and why. In these embodiments, the gaming system 105 or gaming venue host system 125 might have an operator configurable option such as “pick the first image,” “pick a random image,” or the option to pick an image based on some logic or other AI.

According to one embodiment, when the player 130 has logged into the gaming system 105, e.g., using a player tracking card, username, and password, or using a mobile application, the gaming system 105 can report the session start and player id to the gaming venue host system 125. In some cases, the gaming venue host system 125 can look up the player and determine which content, if any, should be provided to the player 130. This could be based on many factors. The gaming system 105 can download the content and display it to the player 130. As the player plays, the gaming system 105 and/or gaming venue host system 125 can record in the game session information 110 which game outcomes are associated with the player 130 and the unique content that was displayed. The type of content provided could be determined by one or more of: unique to the player; based on the player loyalty account status; player history; player category, e.g., “high roller,” “poker player,” etc.; player preferences; time of day or year; randomly; configuration of the gaming system 105, etc.

In one embodiment, the gaming system 105 can store the unique AI generated content per game played on the gaming system 105. This can work when the player 130 is not logged into the gaming system 105. In one embodiment, the gaming system 105 can reach out to the gaming venue host system 125 and or generative AI system 120 to get AI content. This content may not be associated with the player 130, but rather associated with the gaming system 105. The gaming system 105 might independently get new AI content based on one or more of: randomly; based on gaming system 105 activity or performance, based on the gaming venue host system 125 deciding to provide new content; etc.

According to one embodiment, an operator, at the gaming system 105 or gaming venue host system 125, can recall a historically played game. In such cases, the gaming system 105 or gaming venue host system 125 can retrieve the content used during that game session or individual game played from the saved game session information 110. The gaming system 105 or other system (not shown here) can then display the game to the operator as it was played using the content provided. In one embodiment, the historical recall can show the prompt used, the generative AI system 120 and/or type of generative AI used, and the time the content was created. For example, the display of the recalled game can show the time the content was created, that it was created using DALL-E, and the prompt used for DALL-E (“Classic Egyptian Symbols”). Of course, the display can be more intricate as the AI generated content would likely have separate prompts for symbols, paylines, buttons, and background. The presented information may also list sounds or text generated.

In one embodiment, the recall display can show which symbols or content was substituted with AI content. For example, the presented recall display could indicate that the cherry symbol was replace by the AI content “Classic Egyptian Symbol.” In one embodiment, the operator or regulator, i.e., the user of the history function, can toggle between the default and AI generated content to compare the two. This could help an operator or regulator adjust the way the AI content is being generated. For example, the game may use AI generated content that is confusing because two symbols look too similar, so the gaming system 105 and/or gaming venue host system 125 can be updated to not use similar images. In one embodiment, the recall function can allow the operator to revoke or disable the AI generated content in response to the concern. For example, after reviewing the history, the operator or regulator can “revoke” the content such that it will not be used in further games. In a similar embodiment, the operator might simply mark the content “for review” and a separate workflow can perform the content review on the gaming venue host system 125.

In one embodiment, the recall display can show any operator options such as “choose the first image provided” or “randomly chose an image” when the generative AI provides multiple results for a single prompt.

In one embodiment, the operator can review the recall at the gaming venue host system 125 or use a browser to communicate with the gaming venue host system 125. In this embodiment, the operator doesn't need to use the gaming system 105 to display the history.

In one embodiment, the operator can review the recall the game on the gaming system 105 using stored game session information 110 on the gaming system 105 such that the gaming system 105 does not need to contact the gaming venue host system 125 to display the recalled gaming session information 110.

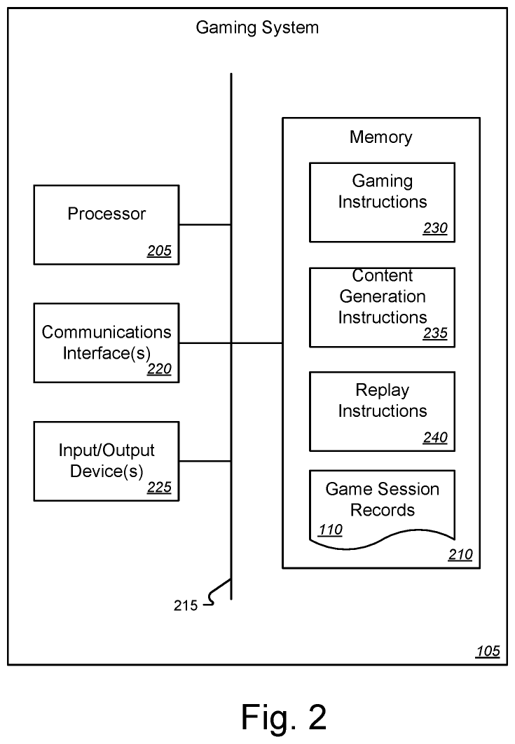

FIG. 2 is a block diagram illustrating additional details of components of an exemplary gaming system according to one embodiment of the present disclosure. As illustrated in this example, a gaming system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 and one or more input/output devices 225 via the communications bus 215. The communication interface(s) 220 can comprise, for example, a Bluetooth, WiFi, cellular, and/or other type of wireless communications interface. Via the communication interface(s) 220, the gaming system 105 can communication with a generative AI system 120, gaming venue host systems 125, regulator system 140, and/or other devices and/or systems through a communications network 115 as described above. The input/output devices 225 can include, but are not limited to a display device such as a Liquid Crystal Display (LCD), Light Emitting Diode (LED), Organic Light Emitting Diode (OLED), or other type of display, a ticket printer, etc.

The memory 210 can store therein a set of gaming instructions 230 which, when executed by the processor 205, cause the processor 205 to execute an electronic game. The electronic game can be any of a wide variety of electronic games of chance including, but not limited to, slots, video slots, video poker, keno, blackjack, etc. to be played by a player, e.g., in a casino or other gaming venue. The memory 210 can also store therein a set of content generation instructions 235. Generally speaking, and as introduced above, the content generation instructions 235, when executed by the processor 205, can cause the processor 205 to generate content for an electronic game by generating a prompt describing content for the electronic game, providing the prompt to a generative AI system 120, receiving the content for the electronic game from the generative AI system 120, and applying the received content for the electronic game to the electronic game according to processes as known in the art.

The content generation instructions 235 can further cause the processor 205 to record in a set of game session records 110 the generated prompt, the received content, and game information for a session of the electronic game to which the received content was applied while the electronic game is executing. The game session records 110 can be maintained by the gaming system 105 or by a gaming venue host system 125 in which case the gaming system 105 can provide any or all of the generated prompt, received content, and/or game information to the gaming venue host system 125 via the communications interface 220. Recording the generated prompt, the received content, and game information for the session of the electronic game to which the received content was applied can comprise recording a unique identifier for the session of the electronic game, a date and time for the session of the electronic game, information identifying the generative AI system, some or all of the received content, an indication of which content of the received content was applied to the session of the electronic game, and/or other information.

According to one embodiment, the memory 210 can also have stored therein a set of replay instructions 240 which, when executed by the processor 205, can cause the processor 205 to provide a replay of the session of the electronic game using the recorded generated prompt, received content, and game information for the session of the electronic game to which the received content was applied and saved in game session records 110 maintained by the gaming system 105 or the gaming venue host system 125. For example, providing a replay of the session of the electronic game using the recorded generated prompt, received content, and game information for the session of the electronic game to which the received content was applied can comprise receiving a request to replay the session of the electronic game using the recorded generated prompt, received content, and game information for the session of the electronic game to which the received content was applied, retrieving the recorded generated prompt, received content, and game information for the session of the electronic game to which the received content was applied, and providing through the display and/or other input/output devices 225 of the gaming system 105 or another system the retrieved generated prompt, received content, and game information for the session of the electronic game to which the received content was applied to the gaming system, display of the gaming system, or to another system to reproduce a representation of the gaming session using processes as known in the art.

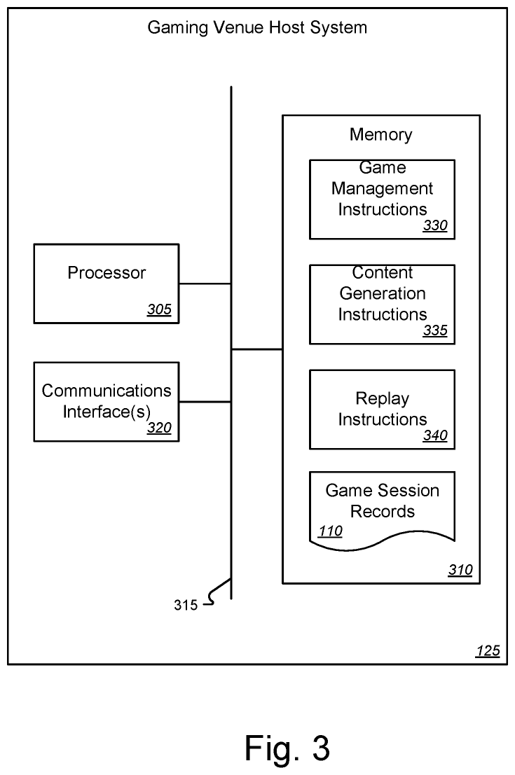

FIG. 3 is a block diagram illustrating additional details of components of an exemplary gaming venue host system according to one embodiment of the present disclosure. As illustrated in this example, a gaming venue host system 125 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320. The communication interfaces 320 can comprise, for example, a Bluetooth, WiFi, cellular, and/or other types of wireless communications interface.

The memory 310 can store therein a set of game management instructions 330 which, when executed by the processor 305, cause the processor 305 to manage one or more gaming systems 105 and/or electronic games executing one the gaming system(s) 105 in various ways a gaming venue as known in the art. The memory 310 can also store therein a set of content generation instructions 335. Generally speaking, and as introduced above, the content generation instructions 335, when executed by the processor 305, can cause the processor 305 to generate content for an electronic game by generating a prompt describing content for the electronic game, providing the prompt to a generative AI system 120, receiving the content for the electronic game from the generative AI system 120, and applying the received content for the electronic game to the electronic game according to processes as known in the art.

The content generation instructions 335 can further cause the processor 205 to record in a set of game session records 110 the generated prompt, the received content, and game information for a session of the electronic game to which the received content was applied while the electronic game is executing. Recording the generated prompt, the received content, and game information for the session of the electronic game to which the received content was applied can comprise recording a unique identifier for the session of the electronic game, a date and time for the session of the electronic game, information identifying the generative AI system, some or all of the received content, an indication of which content of the received content was applied to the session of the electronic game, and/or other information.

According to one embodiment, the memory 310 can also have stored therein a set of replay instructions 340 which, when executed by the processor 305, can cause the processor 305 to provide a replay of the session of the electronic game using the recorded generated prompt, received content, and game information for the session of the electronic game to which the received content was applied and saved in game session records 110 maintained by the gaming system 105 or the gaming venue host system 125. For example, providing a replay of the session of the electronic game using the recorded generated prompt, received content, and game information for the session of the electronic game to which the received content was applied can comprise receiving a request to replay the session of the electronic game using the recorded generated prompt, received content, and game information for the session of the electronic game to which the received content was applied, retrieving the recorded generated prompt, received content, and game information for the session of the electronic game to which the received content was applied, and providing through the communications interface 320 to the gaming system 105 or another system the retrieved generated prompt, received content, and game information for the session of the electronic game to which the received content was applied to the gaming system, display of the gaming system 105, or to another system to reproduce a representation of the gaming session using processes as known in the art.

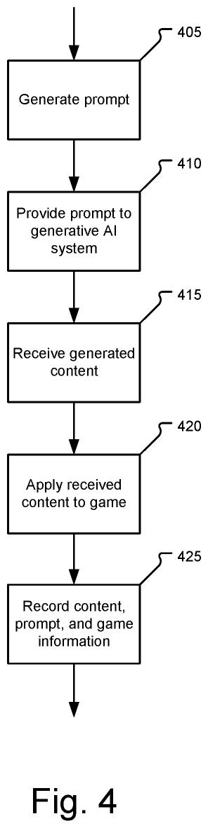

FIG. 4 is a flowchart illustrating an exemplary process for generating content for an electronic game according to one embodiment of the present disclosure. As illustrated in this example, generating content for an electronic game can comprise generating 405 a prompt describing content for the electronic game, providing 410 the prompt to a generative AI system, receiving 415 the content for the electronic game from the generative AI system, and applying 420 the received content for the electronic game to the electronic game according to processes as known in the art. The generated prompt, the received content, and game information for a session of the electronic game to which the received content was applied can then be recorded 425 while the electronic game is executing. Recording 425 the generated prompt, the received content, and game information for the session of the electronic game to which the received content was applied can comprise recording a unique identifier for the session of the electronic game, a date and time for the session of the electronic game, information identifying the generative AI system, some or all of the received content, an indication of which content of the received content was applied to the session of the electronic game, and/or other information.

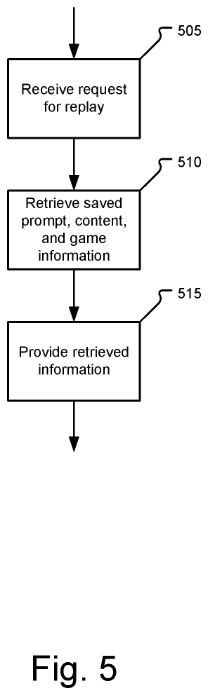

FIG. 5 is a flowchart illustrating an exemplary process for providing a replay function for an electronic game session according to one embodiment of the present disclosure. As illustrated in this example, providing the replay of the session of the electronic game using the recorded generated prompt, received content, and game information for the session of the electronic game to which the received content was applied can comprise receiving 505 a request to replay the session of the electronic game using the recorded generated prompt, received content, and game information for the session of the electronic game to which the received content was applied, retrieving 510 the recorded generated prompt, received content, and game information for the session of the electronic game to which the received content was applied, and providing 515 the retrieved generated prompt, received content, and game information for the session of the electronic game to which the received content was applied to the gaming system, display of the gaming system, or to another system to reproduce a representation of the gaming session using processes as known in the art.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for generating content for an electronic game, the method comprising:
generating, by a processor of a gaming system, a prompt describing content for the electronic game;
providing, by the processor of the gaming system, the prompt to a generative Artificial Intelligence (AI) system;
receiving, by the processor of the gaming system, the content for the electronic game from the generative AI system;
applying, by the processor of the gaming system, the received content for the electronic game to the electronic game; and
recording, by the processor of the gaming system, the generated prompt, the received content, and game information for a session of the electronic game to which the received content was applied.

2. The method of claim 1, wherein recording the generated prompt, the received content, and game information for the session of the electronic game to which the received content was applied comprises recording a unique identifier for the session of the electronic game.

3. The method of claim 1, wherein recording the generated prompt, the received content, and game information for the session of the electronic game to which the received content was applied comprises recording a date and time for the session of the electronic game.

4. The method of claim 1, wherein recording the generated prompt, the received content, and game information for the session of the electronic game to which the received content was applied comprises recording information identifying the generative AI system.

5. The method of claim 1, wherein recording the generated prompt, the received content, and game information for the session of the electronic game to which the received content was applied comprises recording all of the received content.

6. The method of claim 5, wherein recording the generated prompt, the received content, and game information for the session of the electronic game to which the received content was applied comprises recording which content of the received content was applied to the session of the electronic game.

7. The method of claim 1, further comprising providing, by the processor of the gaming system, a replay of the session of the electronic game using the recorded generated prompt, received content, and game information for the session of the electronic game to which the received content was applied.

8. A gaming system comprising:
a processor; and
a memory coupled with and readable by the processor and storing therein a set of instructions which, when executed by the processor, causes the processor to:
generate a prompt describing content for the electronic game;
provide the prompt to a generative Artificial Intelligence (AI) system;
receive the content for the electronic game from the generative AI system;
apply the received content for the electronic game to the electronic game; and
record the generated prompt, the received content, and game information for a session of the electronic game to which the received content was applied.

9. The gaming system of claim 8, wherein recording the generated prompt, the received content, and game information for the session of the electronic game to which the received content was applied comprises recording a unique identifier for the session of the electronic game.

10. The gaming system of claim 8, wherein recording the generated prompt, the received content, and game information for the session of the electronic game to which the received content was applied comprises recording a date and time for the session of the electronic game. 11 The gaming system of claim 8, wherein recording the generated prompt, the received content, and game information for the session of the electronic game to which the received content was applied comprises recording information identifying the generative AI system.

12. The gaming system of claim 8, wherein recording the generated prompt, the received content, and game information for the session of the electronic game to which the received content was applied comprises recording all of the received content.

13. The gaming system of claim 12, wherein recording the generated prompt, the received content, and game information for the session of the electronic game to which the received content was applied comprises recording which content of the received content was applied to the session of the electronic game.

14. The gaming system of claim 8, wherein the instructions further cause the processor to provide a replay of the session of the electronic game using the recorded generated prompt, received content, and game information for the session of the electronic game to which the received content was applied.

15. A gaming venue host system comprising:
a processor; and
a memory coupled with and readable by the processor and storing therein a set of instructions which, when executed by the processor, causes the processor to:
generate a prompt describing content for the electronic game;
provide the prompt to a generative Artificial Intelligence (AI) system;
receive the content for the electronic game from the generative AI system;
apply the received content for the electronic game to the electronic game; and
record the generated prompt, the received content, and game information for a session of the electronic game to which the received content was applied.

16. The gaming venue host system of claim 15, wherein recording the generated prompt, the received content, and the game information for the session of the electronic game to which the received content was applied further comprises recording a unique identifier for the session of the electronic game.

17. The gaming venue host system of claim 15, wherein applying the received content for the electronic game to the electronic game comprises providing the received content for the electronic game to a gaming system on which the session of the electronic game to which the received content was applied is executed.

18. The gaming venue host system of claim 17, wherein the instructions further cause the processor to receive the game information for the session of the electronic game to which the received content was applied from the gaming system.

19. The gaming venue host system of claim 15, wherein the instructions further cause the processor to provide a replay of the session of the electronic game using the recorded generated prompt, received content, and game information for the session of the electronic game to which the received content was applied.

20. The gaming venue host system of claim 19, wherein providing the replay of the session of the electronic game using the recorded generated prompt, received content, and game information for the session of the electronic game to which the received content was applied comprises:
receiving, from a gaming system, a request to replay the session of the electronic game using the recorded generated prompt, received content, and game information for the session of the electronic game to which the received content was applied;
retrieving the recorded generated prompt, received content, and game information for the session of the electronic game to which the received content was applied; and
providing the retrieved generated prompt, received content, and game information for the session of the electronic game to which the received content was applied to the gaming system.
